(19) United States
(12) Patent Application Publication
(10) Pub. No.: US 2015/0324610 A1
(43) Pub. Date: Nov. 12, 2015

(54) METHOD FOR MANAGING SOFTWARE FUNCTIONALITIES IN A CONTROL UNIT

(71) Applicant: Robert Bosch GmbH, Stuttgart (DE)

(72) Inventors: Markus IHLE, Hemmingen (DE); Ingo OPFERKUCH, Ditzingen (DE); Thomas KELLER, Rottweil (DE); Andreas SOENKENS, Remseck Am Neckar (DE); Thomas KUHN, Heilbronn (DE); Stefan SCHNEIDER, Moensheim (DE)

(21) Appl. No.: 14/710,063

(22) Filed: May 12, 2015

(30) Foreign Application Priority Data
May 12, 2014 (DE) 10 2014 208 840.2

(51) Int. Cl. G06F 21/70; G06F 21/60

(52) U.S. Cl. CPC G06F 21/70; G06F 21/60

(57) ABSTRACT

A method and an electronic hardware security module are provided for managing software functionalities in a control unit. The hardware security module records results of a security functionality and acts on software functionalities as a function of the results.

### FIELD OF THE INVENTION

The present invention relates to a method for managing software functionalities in a control unit and to an electronic hardware security module for implementing the method. The managing of software functionalities in particular refers to the activation and deactivation of these software functionalities.

### BACKGROUND INFORMATION

Control units are electronic modules which, for instance, are used in motor vehicles for the control and regulation of functional sequences. For this purpose the control units are assigned to the particular components of the motor vehicle whose operation will be controlled with the aid of the assigned control unit. In order to do so, the control unit reads in data acquired by sensors and influences the operation by controlling actuators.

The described method is used in conjunction with an electronic security module which is utilized in a control unit, especially in the automotive field, in security-relevant areas. In most applications in the security-relevant areas the manipulation-proof or non-monitorable storing of data is an essential requirement. Cryptographic keys, which are utilized in symmetrical or asymmetrical encryption methods, are used for this purpose.

The employed codes and encryption methods constitute secrets that need to be kept hidden from attackers. Other uses in security-relevant areas, for instance, concern the protection against unauthorized modifications, such as the storing of changed serial numbers or odometer readings, the prevention of unauthorized tuning measures, etc.

Hence it is necessary to provide secure environments in control units, in which functionalities that must have access to and/or modify these secrets can be executed. These environments normally have a secure computing unit or CPU, also referred to as secure CPU, as well as a storage module. An environment of this type is called a hardware security module (HSM) in this context. It represents a high-performance module which includes hardware and software components and improves the security and trustworthiness of embedded systems. The HSM helps in particular in protecting security-critical applications and data. The security costs are also able to be reduced by an HSM, while effective protection against attackers is offered at the same time. As far as the basic structure of an HSM is concerned, reference is made to FIG. 3.

### SUMMARY

According to the method introduced here, the HSM is able to activate and deactivate software tasks, time slices and alternative functions once or during an ongoing operation as a function of the results of other security functionalities, such as tuning detection, runtime exceeding, etc.

It should be noted that, through corresponding security criteria, the HSM is able to deactivate software functionalities or software components in order to maintain the remaining functionality, for instance in emergency running mode. If appropriate, it is also possible to use alternative functionalities instead of the deactivated functionalities. For example, this is achieved by a switchover in the system control using the task information that pertains to the particular software.

Because of the switchover, open interfaces, i.e., output variables of the deactivated functionality, are closed again using standard or default values or using training values from the active phase of the functionality. There is also the option of providing interfaces for software to be loaded at a later point in time, such as application software functionalities or apps, in a substitute value adapter. Following a successful plausibility check and authentication of the app, the HSM would then deactivate the substitute adapter or activate the app and always be able to switch back to the original functionality during the operation, should this be warranted.

The use of this functionality makes it possible to increase the security, and runtime resources are able to be spared. The selective activation or deactivation of code components or entire time slices allows certain code components to be executed, e.g., as required for the production. Using the HSM as safety anchor, for example, the training of the vehicle immobilizer is able to be “briefly” activated, simply via a tester authorization, and be deactivated again by the next command “K115-off”.

Additional advantages and developments of the present invention derive from the specification and the appended drawing.

It is understood that the features mentioned above and the features yet to be described may be used not only in the individually given combination but in other combinations or in isolation as well, without departing from the scope of the present invention.

### BRIEF DESCRIPTION OF THE DRAWINGS

FIG. 1 shows a trust pyramid.

FIG. 2 shows functionalities of an HSM in a schematic representation.

FIG. 3 shows the structure of one specific embodiment of the HSM in a schematic representation.

FIG. 4 shows a specific embodiment of a control unit.

### DETAILED DESCRIPTION

The present invention is represented schematically in the drawing on the basis of specific embodiments and described in the following text with reference to the drawing.

To trust an IT system that it will always act as expected requires trust in all of the incorporated layers, one after the other, in order to create a trustworthy IT system.

FIG. 1 shows a trust pyramid for a typical IT system. It is provided with reference number 10 overall and includes one layer for organizational security 12, one layer for system security 14, one layer for hardware security 16, one layer for software security 18, and an uppermost layer for trust 20.

Trust in the entire IT system requires that each layer is able to rely on the effective security of the layer situated underneath, without having the ability to verify this fact independently. For example, this means that it is possible that a perfect software and hardware security solution may turn out to be useless because of a weak security system design situated underneath. Moreover, it may be the case that a potential weakness in the system design will not be detected or prevented by the upper hardware and software layers.

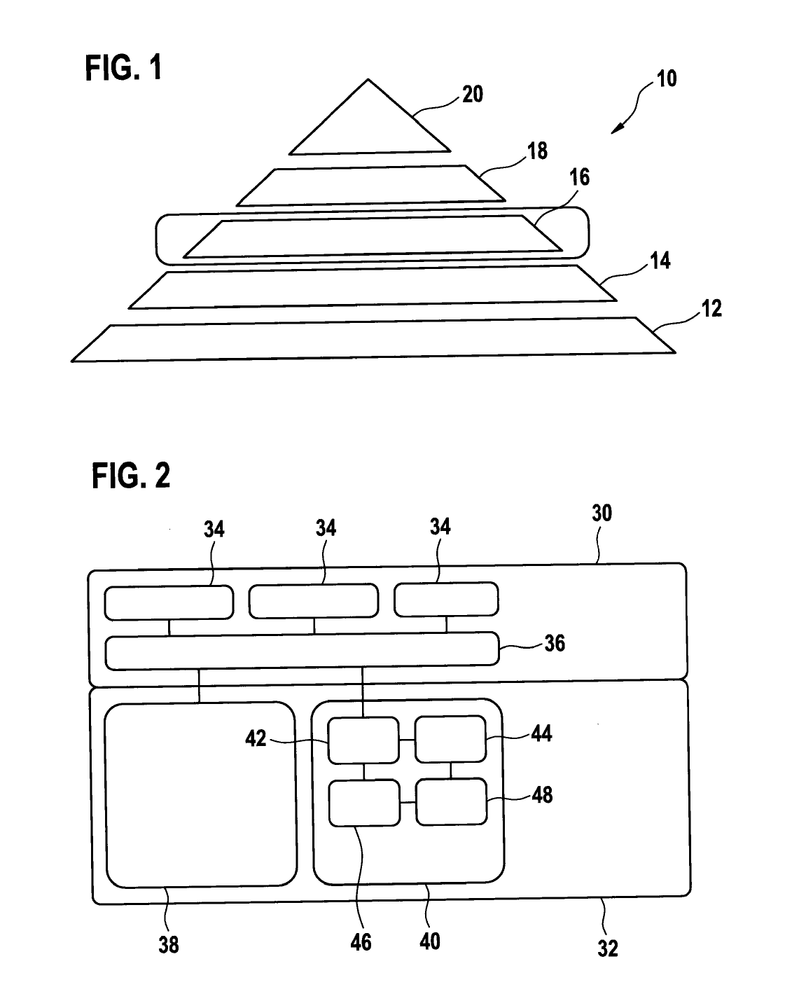

In contrast to typical back and IT systems, the hardware layer of embedded systems is frequently exposed to physical attacks that influence hardware or software functionalities through physical means, e.g., manipulate a flash memory or deactivate alarm functionalities. One particular approach for making such physical attacks more difficult is the use of manipulation-proof hardware security modules (HSM), such as those shown in FIG. 2, for instance. Such an HSM protects important information, e.g., personal identification numbers (PIN), secure keys and critical operations such as a PIN verification, data encryption, for example by strong physical shielding.

The manner in which an HSM may be developed and the kind of functionalities that are able to be performed thereby in order to improve the security of an embedded system will be shown in the following text.

FIG. 2 depicts the core functionalities of a typical hardware security module. The illustration shows a software layer 30 and a hardware layer 32 which is protected against unauthorized access.

Software layer 30 includes a number of applications 34, three of which are shown in this instance. An operating system 36 is provided in addition. Hardware layer 32 includes embedded standard hardware 38 and a hardware security module (HSM) 40. A first block 42 in this HSM 40 is provided for interfaces and the control, a second block 44 is provided for secure encryption functionalities, a third block 46 is provided for secure functionalities, and a secure memory 48 is included.

Secure memory 48 is a small, non-volatile data memory, e.g., having a capacity of a few kilobytes, within manipulation-proof HSM 40, so that an unauthorized readout or a manipulation or deletion of critical information, e.g., of cryptographic keys, cryptographic certificates or authentication data such as PINs or passwords, is prevented. Secure memory 48 of HSM 40 in addition holds all HSM configuration information, such as information pertaining to the owner of HSM 40, or access authorizations to secure internal units.

Second block 44 for secure encryption functionalities holds cryptographic algorithms which are used for data encryption and decoding, such as AES or 3DES, data integrity amplification, such as MAC or HMAC, or a data origin verification, e.g., through the use of digital signature algorithms such as RSA or ECC, as well as all associated cryptographic activities, such as key generation and key verification, for instance.

Secure functionalities in third block 46 include all protected functionalities that are not directly assigned to a cryptographic method, HSM 40 serving as physically protected “trust anchor”. For example, this may be a physically protected clock signal, an internal random-number generator, a loading routine protection mechanism or some other critical application functionality, for instance for realizing a secure dongle.

First block 42 for interfaces and the control includes the internal HSM logic, which implements the HSM communication with the external world and administers the operation of all internal basic components such as the ones previously mentioned.

All functional basic components of hardware security module 40, as described above, are surrounded by an uninterrupted physical boundary, which prevents internal data and processes from being monitored, copied or cloned or manipulated. This could enable an unauthorized user to use or compromise internal secrets. The cryptographic boundary is commonly implemented by algorithmic and physical time channel countermeasures with dedicated access protection means, such as special shielding or layers in order to enable side channel resistance, access reporting, access resistance or an access response, for instance.

The manner in which HSM 40 is able to improve the security of an embedded product solution will be elucidated in the following text.

HSM 40 protects critical information, e.g., identities, cipher keys or keys by the physical shield, which cannot be circumvented by software susceptibility.

HSM 40 is able to assist in detecting, weakening or deterring powerful POI attackers (POI=point of interest), by implementing effective side channel resistance and access protection barriers, which, among other things, have severe access restrictions that apply even to authorized users. For example, some information is always held within HSM 40 exclusively.

HSM 40 is able to accelerate security mechanisms in which certain acceleration switching circuits are utilized.

The use of HSM 40 makes it possible to reduce the security costs by adding highly optimized special switching circuits, for instance for standardized cryptography.

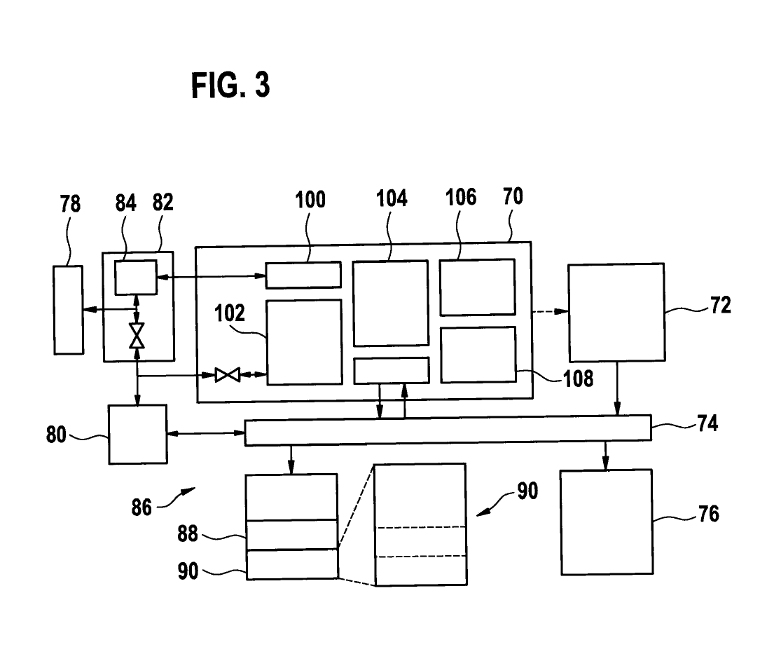

One possible structure of the HSM is shown in FIG. 3. It shows HSM 70, which is embedded in an environment. The figure depicts a main computing unit 72, a system bus 74, a RAM component 76 having an area for joint use, and a test program 78 or debugger including associated hardware 80 and interface 82, which in turn includes a register 84.

Moreover, the figure shows a memory component 86 for flash code having a data area 88 and a secure area 90, in which secure core data are contained.

Provided in HSM 70 are an interface 100 to test program 78, a secure computing core 102, a secure RAM component 104, a random-number generator 106, e.g., a TRNG or PRNG, and a key 108, e.g., AES.

In the introduced method, already existing mechanisms for detecting a manipulation, e.g., using real time track data (RTTD), or the exceeding of storage limits, e.g., by means of MPU, Hypervisor, and runtime limits, e.g., using watchdog, or operating system, are able to be analyzed by HSM, and the deactivation of functionalities or the switchover to alternative functionalities may possibly be inferred therefrom.

Via the MPU, for example, it is determined whether the functionality leaves the memory area it was assigned. As an alternative or in addition, it can be determined via the watchdog whether the functionality violates the demands on the runtime. There is a close connection between the operating system of the main computer core and the HSM, i.e., the HSM can regularly supply the operating system with information as to whether a functionality is allowed to be executed.

The existing security infrastructure is used for activating new performance features. This concept allows retroactive programming of the new feature. It should be noted that features to be activated are currently already on board. In the event that a retroactively installed application does not work properly, a return to the previous software is able to take place.

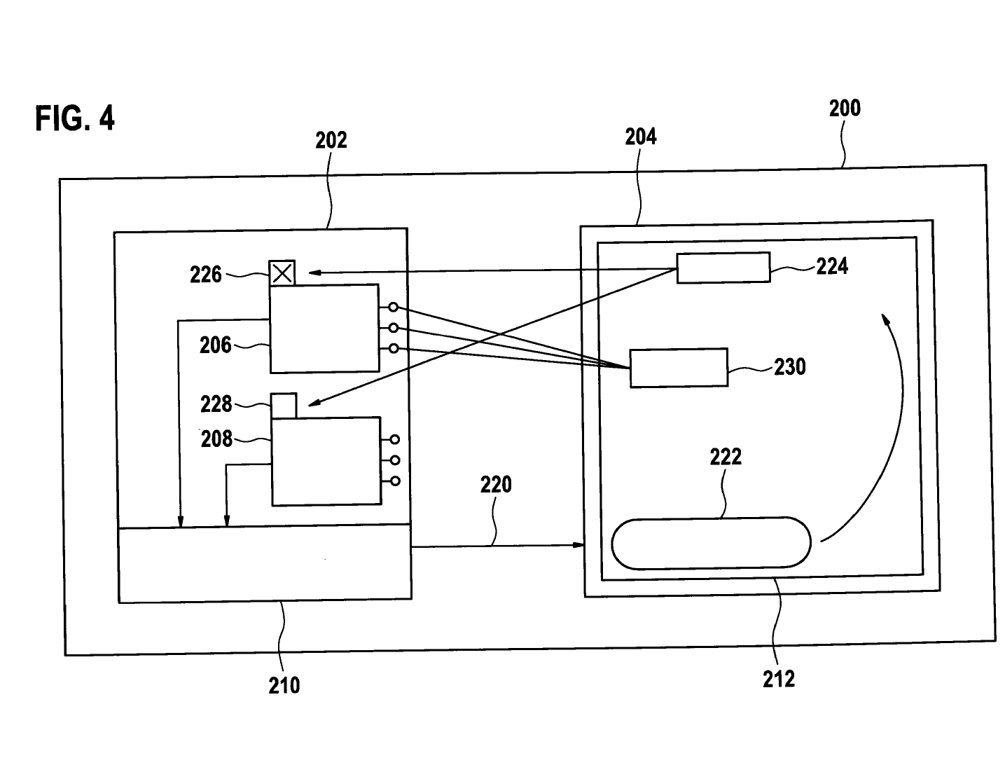

FIG. 4 shows one development of a control unit, which is denoted by 200 overall. This control unit 200 includes a main computer unit (core) 202 and an electronic hardware security module (HSM) 204. A first software functionality 206, functionality A, and a second software functionality 208, functionality A′, are stored in main computer unit 202. A memory 210 for implementing software functionalities 206 and 208 at the runtime is provided in addition.

A secure computer unit 212, which is protected against external attacks and satisfies certain security specifications specified for this purpose, is provided in HSM 204.

If a violation 220, e.g., an unauthorized access to one of software functionalities 206 or 208 is recorded, or a runtime violation, i.e., an exceeding of runtime limits, which is able to be detected by main computer unit 202 or by HSM 204, then this will be analyzed within secure computer unit 212 in an evaluation logic, which represents a security functionality 222, and the result of the evaluation is forwarded to a switching unit 224 within secure computer unit 212. This switching unit 224 indicates which software functionalities 206 or 208 are to be activated or deactivated, which is done on the basis of an evaluation of security specifications or on the basis of a consideration as to which functionalities are to be activated. In the example shown, first software functionality 206 is activated 226, and second software functionality 208 is deactivated 228.

Moreover, learned output values 230 for alternative functionalities are forwarded by secure computer unit 212 to software functionalities 206 and 208, in this instance, to activated first software functionality 206.

It may also be provided that HSM 204 regularly supplies information to main computer unit 202 as to whether software functionalities 206 and 208 may be implemented.

What is claimed is:

1. A method for managing a software functionality in a control unit, which has a hardware security module, comprising:
recording, by the hardware security module, a result of a security functionality; and
acting, by the hardware security module, on a software functionality that is implemented on a main computer unit in the control unit as a function of the result.

2. The method as recited in claim 1, wherein the software functionality is activated.

3. The method as recited in claim 1, wherein the software functionality is deactivated.

4. The method as recited in claim 3, further comprising switching to an alternative functionality.

5. The method as recited in claim 1, further comprising detecting a manipulation, wherein the software functionality is influenced as a result.

6. The method as recited in claim 1, detecting an exceeding of a memory limit, wherein the software functionality is influenced as a result.

7. The method as recited in claim 1, detecting an exceeding of a runtime limit, wherein the software functionality is influenced as a result.

8. The method as recited in claim 1, wherein an HSM of the main computer unit of the control unit regularly outputs information as to whether the software functionality may be executed.

9. An electronic hardware security module for managing a software functionality in a control unit, comprising:
a secure computer unit for detecting a result of a security functionality and for acting on a software functionality that is implemented on a main computer unit in the control unit as a function of the result.
